(19) United States
(12) Patent Application Publication
(10) Pub. No.: US 2026/0163251 A1
(43) Pub. Date: Jun. 11, 2026

(54) ANTENNA ELEMENT, ANTENNA, AND COMMUNICATION DEVICE

(71) Applicant: HUAWEI TECHNOLOGIES CO., LTD., Shenzhen (CN)

(72) Inventors: Zijing Du, Xi'an (CN); Jun Shu, Dongguan (CN); Dingjiu Daojian, Dongguan (CN); Jie Yao, Dongguan (CN); Jiongsai Zhou, Shenzhen (CN)

(73) Assignee: HUAWEI TECHNOLOGIES CO., LTD., Shenzhen (CN)

(21) Appl. No.: 19/463,798

(22) Filed: Jan. 29, 2026

Related U.S. Application Data
(63) Continuation of application No. PCT/CN2024/106156, filed on Jul. 18, 2024.

(30) Foreign Application Priority Data
Jul. 31, 2023 (CN) 202310947784.8

(51) Int. Cl. H01Q 19/10; H01Q 1/24; H01Q 5/30

(52) U.S. Cl. CPC H01Q 19/10; H01Q 1/246; H01Q 5/30

(57) ABSTRACT

An antenna element, an antenna, and a communication device are provided. The antenna element includes a radiation arm, a feed line, and a decoupling stub, wherein the radiation arm is connected to the feed line. The decoupling stub includes a first stub and a second stub, the first stub is parallel to the feed line, and an end of the first stub is connected to the feed line. The second stub is located on a first side of the first stub away from the radiation arm, the second stub is connected to the first stub, the second stub extends from the first stub to a second side away from the feed line, and the second stub is perpendicular to the feed line.

### CROSS-REFERENCE TO RELATED APPLICATIONS

This application is a continuation of International Application No. PCT/CN 2024/106156, filed on Jul. 18, 2024, which claims priority to Chinese Patent Application No. 202310947784.8, filed on Jul. 31, 2023. The disclosures of the aforementioned applications are hereby incorporated by reference in their entireties.

### TECHNICAL FIELD

This application relates to the field of communication technologies, and in particular, to an antenna element, an antenna, and a communication device.

### BACKGROUND

In a communication device such as a base station, both a high-frequency antenna element and a low-frequency antenna element are usually configured. The high-frequency antenna element has a large signal transmission capacity, and the low-frequency antenna element has a strong a signal anti-attenuation capability. To reduce a size of the communication device, the high-frequency antenna element and the low-frequency antenna element may be configured in a same antenna array plane to form a multi-band antenna.

In the multi-band antenna, a spacing between the high-frequency antenna element and the low-frequency antenna element is usually small. Therefore, when an electromagnetic wave radiated by the low-frequency antenna element is coupled to the high-frequency antenna element, common-mode resonance is generated on the high-frequency antenna element, so that a low-frequency induced current is excited on a radiating part and a reflection ground of the high-frequency antenna element, and the induced current further stimulates a low-frequency electromagnetic wave. The low-frequency electromagnetic wave is superimposed with an electromagnetic wave directly radiated by the low-frequency antenna element, causing deterioration of directivity pattern parameters such as gain stability and a polarization suppression ratio of the low-frequency antenna element.

### SUMMARY

This application provides an antenna element, an antenna, and a communication device, to improve a directivity pattern parameter of the antenna element.

According to a first aspect, this application provides an antenna element. The antenna element includes a radiation arm, a feed line, and a decoupling stub. The radiation arm is connected to the feed line. The decoupling stub includes a first stub and a second stub, the first stub is parallel to the feed line, and an end that is of the first stub and that is close to the radiation arm is connected to the feed line. The second stub is located on a side that is of the first stub and that is away from the radiation arm, the second stub is connected to the first stub, the second stub extends from the first stub to a side that is away from the feed line, and the second stub is perpendicular to the feed line. In an antenna according to some embodiments, the feed line and the decoupling stub of the antenna element are connected, so that currents on the first stub and the feed line can be at least partially offset, thereby reducing interference of the antenna element to another antenna element that generates a common-mode induced current on the antenna element. In addition, because the second stub extends toward the side that is away from the feed line, a gain-drop point of another antenna element that generates a common-mode induced current on the antenna element may be moved outside an operating frequency band, so that radiation of the antenna element on which the decoupling stub is disposed is not affected when directivity pattern parameters such as a polarization suppression ratio and gain stability of the another antenna element are effectively improved.

In some embodiments, when the decoupling stub is disposed, a length of the first stub is 0.125 to 0.25 times a wavelength corresponding to an operating frequency of the antenna element. The length of the first stub is set to the foregoing range, so that currents on the first stub and an electrode line of the feed line can be at least partially offset, thereby greatly reducing interference of the antenna element to another antenna element that generates a common-mode induced current on the antenna element.

In addition, a length of the second stub is 0.125 to 0.25 times the wavelength corresponding to the operating frequency of the antenna element. This can make a gain-drop resonance point of another antenna element that generates a common-mode induced current on the antenna element outside an operating frequency band, so that interference of the antenna element to the another antenna element is reduced, thereby improving directivity pattern parameters such as a polarization suppression ratio and gain stability of the another antenna element.

Based on the foregoing descriptions of the lengths of the first stub and the second stub of the decoupling stub, a sum of the length of the first stub and the length of the second stub is 0.25 to 0.5 times the wavelength corresponding to the operating frequency of the antenna element, to improve directivity pattern parameters such as a polarization suppression ratio and gain stability of another antenna element that generates a common-mode induced current on the antenna element.

In some embodiments, the length of the first stub is less than or equal to a length of the feed line. In this way, currents on the first stub and an electrode line of the feed line can be partially offset, thereby reducing interference of the antenna element to another antenna element that generates a common-mode induced current on the antenna element.

In some embodiments, when the first stub is connected to the feed line, the end that is of the first stub and that is close to the radiation arm is connected to an end that is of the feed line and that is connected to the radiation arm. This can help offset currents on the first stub and an electrode line of the feed line, thereby helping reduce interference of the antenna element to another antenna element that generates a common-mode induced current on the antenna element.

The feed line may generally include a first electrode line and a second electrode line. The first electrode line and the second electrode line are disposed in parallel. In this example, the end that is of the first stub and that is close to the radiation arm may be connected to at least one of the first electrode line and the second electrode line.

In some embodiments, the end that is of the first stub and that is close to the radiation arm is connected to the first electrode line. The decoupling stub and the first electrode line may be disposed on a same plane, so that the first stub can be conveniently connected to the first electrode line. In addition, a plane on which the decoupling stub is located may alternatively be perpendicular to and intersect a plane on which the first electrode line is located, which may be designed depending on the structure of the antenna.

In some embodiments, the end that is of the first stub and that is close to the radiation arm is connected to the second electrode line. The decoupling stub and the second electrode line may be disposed on a same plane, so that the first stub can be conveniently connected to the second electrode line. In addition, a plane on which the decoupling stub is located may alternatively be perpendicular to and intersect a plane on which the second electrode line is located, which may be designed depending on the structure of the antenna.

In some embodiments, the antenna element includes two decoupling stubs, and each decoupling stub may be connected to one electrode line of the feed line. Specifically, an end that is of a first stub of one decoupling stub and that is close to the radiation arm is connected to the first electrode line, and an end that is of a first stub of the other decoupling stub and that is close to the radiation arm is connected to the second electrode.

It may be understood that, when the antenna element includes two decoupling stubs, one decoupling stub and the first electrode line may be disposed on a same plane, to implement a connection between the first stub and the first electrode line. Alternatively, depending on the structure of the antenna, a plane on which the one decoupling stub is located may be designed to be perpendicular to and intersect a plane on which the first electrode line is located.

In addition, the other decoupling stub of the two decoupling stubs and the second electrode line may be disposed on a same plane, to implement a connection between the first stub and the second electrode line. Alternatively, depending on the structure of the antenna, a plane on which the other decoupling stub is located may be designed to be perpendicular to and intersect a plane on which the second electrode line is located.

In some embodiments, in addition to the foregoing structures, the antenna element may further include two dielectric substrates. The two dielectric substrates are perpendicular and intersect, and each dielectric substrate is perpendicular to a reflection plate. Other structures such as the feed line and the decoupling stub of the antenna element may be disposed on the two dielectric substrates. For example, the feed line may be a microstrip structure, both the dielectric substrates are provided with feed lines, and a first electrode line and a second electrode line of each feed line are respectively disposed on two surfaces of a corresponding dielectric substrate, to avoid a short circuit of the two electrode lines of the feed line.

In some embodiments, the radiation arm includes a first radiation arm, a second radiation arm, a third radiation arm, and a fourth radiation arm, the first radiation arm and the second radiation arm may be disposed on one dielectric substrate, and the third radiation arm and the fourth radiation arm may be disposed on the other dielectric substrate. In addition, the first radiation arm, the second radiation arm, the third radiation arm, and the fourth radiation arm are disposed on a same radiation surface. The end that is of the first stub and that is close to the radiation arm is located on the radiation surface. This helps offset currents on the first stub and an electrode line of the feed line, thereby helping reduce interference of the antenna element to a low-frequency antenna element.

According to a second aspect, this application further provides an antenna. The antenna includes a reflection plate and the antenna element according to the first aspect, the antenna element is disposed on a surface of one side of the reflection plate, and the first stub is perpendicular to the reflection plate. In the antenna according to some embodiments, the feed line and the decoupling stub of the antenna element are connected, so that currents on the first stub and the feed line can be at least partially offset, thereby reducing interference of the antenna element to another antenna element nearby. In addition, because the second stub extends toward the side that is away from the feed line, a gain-drop point of another antenna element that generates a common-mode induced current on the antenna element may be moved outside an operating frequency band of the another antenna element, so that radiation of the antenna element on which the decoupling stub is disposed is not affected when directivity pattern parameters such as a polarization suppression ratio and gain stability of the another antenna element are effectively improved.

According to a third aspect, this application further provides an antenna. The antenna includes a reflection plate and an antenna element, the antenna element is disposed on a surface of one side of the reflection plate, and the antenna element includes a feed line and a decoupling stub. The decoupling stub includes a first stub and a second stub, the first stub is perpendicular to the reflection plate, and an end that is of the first stub and that is away from the reflection plate is connected to the feed line. The second stub is located on a side that is of the first stub and that is close to the reflection plate, the second stub is connected to the first stub, the second stub extends from the first stub to a side that is away from the feed line, and the second stub is parallel to the reflection plate. In the antenna according to some embodiments, the feed line and the decoupling stub of the antenna element are connected, so that currents on the first stub and the feed line can be at least partially offset, thereby reducing interference of the antenna element to another antenna element nearby. In addition, because the second stub extends toward the side that is away from the feed line, a gain-drop point of another antenna element near the antenna element may be moved outside an operating frequency band of the another antenna element, so that radiation of the antenna element on which the decoupling stub is disposed is not affected when directivity pattern parameters such as a polarization suppression ratio and gain stability of the another antenna element are effectively improved.

The antenna according to some embodiments is a multi-band antenna, and the antenna element may include at least one low-frequency antenna element and at least one high-frequency antenna element. In addition, the feed line is configured to feed the high-frequency antenna element. In this way, in the multi-band antenna, interference of the high-frequency antenna element to the low-frequency antenna element can be effectively reduced, so that directivity pattern parameters such as a polarization suppression ratio and gain stability of the low-frequency antenna element can be improved, and the high-frequency antenna element also has good radiation performance.

In some embodiments, when the decoupling stub is disposed, a length of the first stub is 0.125 to 0.25 times a wavelength corresponding to an operating frequency of the high-frequency antenna element. The length of the first stub is set to the foregoing range, so that currents on the first stub and an electrode line of the feed line can be at least partially offset, thereby greatly reducing interference of the high-frequency antenna element to the low-frequency antenna element.

In addition, a length of the second stub is 0.125 to 0.25 times the wavelength corresponding to the operating frequency of the high-frequency antenna element. This can make a gain-drop resonance point of a low-frequency antenna outside an operating frequency band of the low-frequency antenna, so that interference of the high-frequency antenna element to the low-frequency antenna element is reduced, thereby improving directivity pattern parameters such as a polarization suppression ratio and gain stability of the low-frequency antenna element.

Based on the foregoing descriptions of the lengths of the first stub and the second stub of the decoupling stub, a sum of the length of the first stub and the length of the second stub is 0.25 to 0.5 times the wavelength corresponding to the operating frequency of the high-frequency antenna element, to improve directivity pattern parameters such as a polarization suppression ratio and gain stability of the low-frequency antenna element.

In some embodiments, there is a specific spacing between the second stub and a surface of the reflection plate, to avoid a short circuit between the second stub and the reflection plate. The spacing between the second stub and the reflection plate may be less than or equal to 0.1 times the wavelength corresponding to the operating frequency of the high-frequency antenna element. This can make a gain-drop resonance point of the low-frequency antenna element move outside an operating frequency band of the low-frequency antenna element, and can also avoid impact on radiation of the high-frequency antenna element.

In some embodiments, the length of the first stub is less than or equal to a length of the feed line. In this way, currents on the first stub and an electrode line of the feed line can be partially offset, thereby reducing interference of the high-frequency antenna element to the low-frequency antenna element.

In some embodiments, when the first stub is connected to the feed line, the end that is of the first stub and that is away from the reflection plate is connected to an end that is of the feed line and that is away from the reflection plate. This can help offset currents on the first stub and an electrode line of the feed line, thereby helping reduce interference of the high-frequency antenna element to the low-frequency antenna element.

The feed line may generally include a first electrode line and a second electrode line, the first electrode line is perpendicular to the reflection plate, the second electrode line is perpendicular to the reflection plate, and the second electrode line is connected to the reflection plate. Therefore, the first electrode line is a positive electrode line, and the second electrode line is a negative electrode line. In this example, the end that is of the first stub and that is away from the reflection plate may be connected to at least one of the first electrode line and the second electrode line.

For example, In some embodiments, the end that is of the first stub and that is away from the reflection plate is connected to the first electrode line. The decoupling stub and the first electrode line may be disposed on a same plane, so that the first stub can be conveniently connected to the first electrode line. In addition, a plane on which the decoupling stub is located may alternatively be perpendicular to and intersect a plane on which the first electrode line is located, which may be designed depending on the structure of the antenna.

In some embodiments, the end that is of the first stub and that is away from the reflection plate is connected to the second electrode line. The decoupling stub and the second electrode line may be disposed on a same plane, so that the first stub can be conveniently connected to the second electrode line. In addition, a plane on which the decoupling stub is located may alternatively be perpendicular to and intersect a plane on which the second electrode line is located, which may be designed depending on the structure of the antenna.

In some embodiments, the high-frequency antenna element includes two decoupling stubs, and each decoupling stub may be connected to one electrode line of the feed line. Specifically, an end that is of a first stub of one decoupling stub and that is away from the reflection plate is connected to the first electrode line, and an end that is of a first stub of the other decoupling stub and that is away from the reflection plate is connected to the second electrode.

It may be understood that, when the high-frequency antenna element includes two decoupling stubs, one decoupling stub and the first electrode line may be disposed on a same plane, to implement a connection between the first stub and the first electrode line. Alternatively, depending on the structure of the antenna, a plane on which the one decoupling stub is located may be designed to be perpendicular to and intersect a plane on which the first electrode line is located.

In addition, the other decoupling stub of the two decoupling stubs and the second electrode line may be disposed on a same plane, to implement a connection between the first stub and the second electrode line. Alternatively, depending on the structure of the antenna, a plane on which the other decoupling stub is located may be designed to be perpendicular to and intersect a plane on which the second electrode line is located.

In some embodiments, in addition to the foregoing structures, the high-frequency antenna element may further include two dielectric substrates. The two dielectric substrates are perpendicular and intersect, and each dielectric substrate is perpendicular to the reflection plate. Other structures such as the feed line and the decoupling stub of the high-frequency antenna element may be disposed on the two dielectric substrates. For example, the feed line may be a microstrip structure, the feed line may be disposed on each dielectric substrate, and the first electrode line and the second electrode line of each feed line are respectively disposed on two surfaces of the corresponding dielectric substrate, to avoid a short circuit of the two electrode lines of the feed line.

In some embodiments, the high-frequency antenna element further includes a first radiation arm, a second radiation arm, a third radiation arm, and a fourth radiation arm, the first radiation arm and the second radiation arm may be disposed on one dielectric substrate, and the third radiation arm and the fourth radiation arm may be disposed on the other dielectric substrate. In addition, the first radiation arm, the second radiation arm, the third radiation arm, and the fourth radiation arm are disposed on a same radiation surface. The end that is of the first stub and that is away from the reflection plate is located on the radiation surface. This helps offset currents on the first stub and an electrode line of the feed line, thereby helping reduce interference of the high-frequency antenna element to the low-frequency antenna element.

According to a fourth aspect, this application further provides a communication device. The communication device includes the antenna element according to the first aspect, or the communication device includes the antenna according to the second aspect or the third aspect. The communication device may be but is not limited to a base station, a radar, or another device. In the communication device, the decoupling stub is disposed in the antenna element, so that radiation of the antenna element is not affected when directivity pattern parameters such as a polarization suppression ratio and gain stability of another antenna element that generates a common-mode induced current on the antenna element are improved, thereby helping improve communication performance of the communication device.

### BRIEF DESCRIPTION OF DRAWINGS

FIG. 1 is a diagram of a system architecture to which an antenna is applicable according to an embodiment of this application;

FIG. 2 is a diagram of a structure of an antenna feeder system of a base station according to an embodiment of this application;

FIG. 3 is a diagram of a structure of an antenna of a base station according to an embodiment of this application;

FIG. 4 is a diagram of a simplified structure of a dual-band antenna according to an embodiment of this application;

FIG. 5 is a diagram of a simplified structure of an antenna according to an embodiment of this application;

FIG. 6 is a diagram of a partial structure of an antenna according to an embodiment of this application;

FIG. 7 is a diagram of a structure of the other dielectric substrate of a high-frequency antenna element of the antenna provided in FIG. 6;

FIG. 8 shows a curve of a gain simulation result of a low-frequency antenna element of the antenna shown in FIG. 6 and FIG. 7;

FIG. 9 is a diagram of another partial structure of an antenna according to an embodiment of this application;

FIG. 10 is a diagram of a structure of the other dielectric substrate of a high-frequency antenna element of the antenna provided in FIG. 9;

FIG. 11 is a diagram of another partial structure of an antenna according to an embodiment of this application;

FIG. 12 is a diagram of a structure of the other dielectric substrate of a high-frequency antenna element of the antenna provided in FIG. 11;

FIG. 13 is a diagram of another partial structure of an antenna according to an embodiment of this application;

FIG. 14 is a diagram of a manner of connecting a first electrode line on the other dielectric substrate of a high-frequency antenna element of the antenna provided in FIG. 13 to a corresponding decoupling stub;

FIG. 15 is a diagram of another partial structure of an antenna according to an embodiment of this application; and

FIG. 16 is a diagram of a manner of connecting a second electrode line on the other dielectric substrate of a high-frequency antenna element of the antenna provided in FIG. 15 to a corresponding decoupling stub.

### REFERENCE NUMERALS

10—antenna; 1—radiating part; 2—reflection plate; 3—feeding structure; 301—transmission component; 302—calibration network;
303—phase shifter; 304—combiner; 305—filter;
101—high-frequency antenna element; 102—low-frequency antenna element; 1011—feed line; 10111—first electrode line;
10112: second electrode line; 1012: decoupling stub; 10121: first stub; 10122: second stub;
1013: radiation arm; 10131: first radiation arm; 10132: second radiation arm; 10133: third radiation arm;
10134—fourth radiation arm; 1014—dielectric substrate;
20—pole; 30—antenna adjustment bracket; 40—radome; 50—radio frequency processing unit; 60—signal processing unit; and
70: cable.

### DETAILED DESCRIPTION

Terms used in the following embodiments are merely intended to describe specific embodiments, but are not intended to limit this application. Terms “one”, “a”, and “the” of singular forms used in this specification and the appended claims of this application are also intended to include a form like “one or more”, unless otherwise specified in the context clearly. In this specification, terms “include”, “have”, and their variants all mean “include but not limited to”, unless otherwise emphasized in another manner.

To facilitate understanding of an antenna provided in embodiments of this application, the following describes an application scenario of the antenna. The antenna provided in embodiments of this application may be used in a communication device such as a base station. FIG. 1 is a diagram of a system architecture to which an antenna is applicable according to an embodiment of this application. The system architecture may include a communication device and a terminal, and wireless communication may be implemented between the communication device and the terminal. The communication device may be, for example, a base station. The communication device may be located in a base station subsystem (BBS), a terrestrial radio access network (UTRAN), or an evolved terrestrial radio access network (E-UTRAN), and is configured to perform cell coverage of a radio signal, to implement a connection between a terminal device and a wireless network radio frequency end. Specifically, the base station may be a base transceiver station (BTS) in a GSM system or a CDMA system, or may be a NodeB (NB) in a WCDMA system, or may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a base station in a 5G network, a base station in a future evolved public land mobile network (PLMN), or the like, for example, a new radio base station. This is not limited in embodiments of this application.

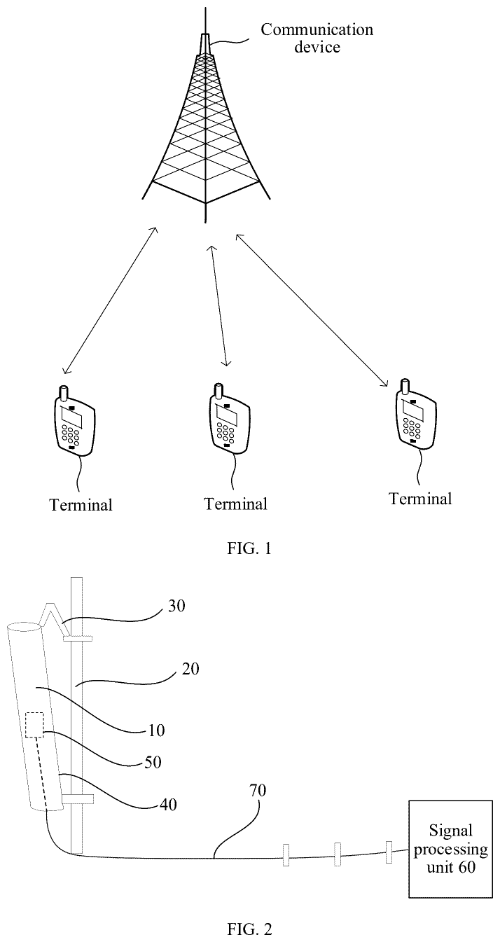

FIG. 2 is a diagram of a structure of an antenna feeder system of a base station according to an embodiment of this application. The antenna feeder system of the base station may generally include structures such as an antenna 10, a pole 20, and an antenna adjustment bracket 30. The antenna 10 of the base station is generally disposed in the radome 40, and the radome 40 has a good electromagnetic wave penetration characteristic in terms of electrical performance, and can withstand impact of an external harsh environment in terms of mechanical performance, thereby protecting the antenna system from being affected by the external environment. The radome 40 may be mounted on the pole 20 or a tower through the antenna adjustment bracket 30, to facilitate signal receiving or transmitting of the antenna 10.

In addition, the base station may further include a radio frequency processing unit 50 and a signal processing unit 60. The radio frequency processing unit 50 may be configured to: perform frequency selection, amplification, and down-conversion processing on a radio signal received by the antenna 10, convert the signal into an intermediate frequency signal or a baseband signal, and send the intermediate frequency signal or the baseband signal to the signal processing unit 60; or is configured to: perform up-conversion and amplification processing on an intermediate frequency signal sent by the signal processing unit 60, convert the signal into an electromagnetic wave through the antenna 10, and send the electromagnetic wave. The signal processing unit 60 may be connected to a feeding structure of the antenna 10 through the radio frequency processing unit 50, and is configured to process an intermediate frequency signal or a baseband signal sent by the radio frequency processing unit 50.

In the embodiment shown in FIG. 2, the radio frequency processing unit 50 may be integrated with the antenna 10, and the signal processing unit 60 is located at a remote end of the antenna 10. Alternatively, both the radio frequency processing unit 50 and the signal processing unit 60 may alternatively be located at a remote end of the antenna 10. In this embodiment of this application, the radio frequency processing unit 50 and the signal processing unit 60 may be connected through a cable 70.

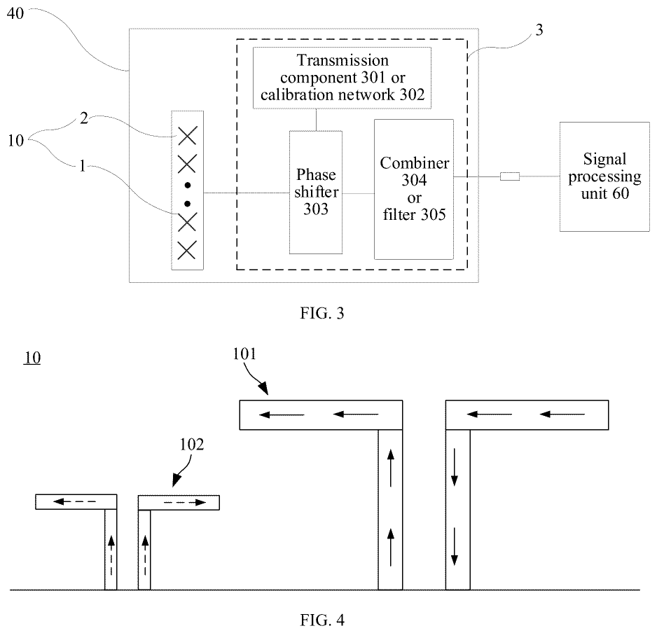

FIG. 3 is a diagram of a structure of an antenna of a base station according to an embodiment of this application. As shown in FIG. 3, the antenna 10 of the base station may include a radiating part 1 and a reflection plate 2. The radiating part 1 may also be referred to as an antenna element, an element, or the like. The radiating part 1 is a unit that forms a basic structure of an antenna array, and can effectively radiate or receive a radio wave. In the antenna 10, operating frequencies of all radiating parts 1 may be the same or different.

In addition, the reflection plate 2 may also be referred to as a bottom plate, an antenna panel, a metal reflective surface, or the like. The reflection plate 2 may improve receiver sensitivity of an antenna signal, and reflect and aggregate the antenna signal on a receiving point. In addition, the reflection plate 2 may implement directional radiation of the antenna signal, and improve radiation performance of the antenna 10. The radiating part 1 is generally disposed on a surface of one side of the reflection plate 2, which can greatly enhance a signal receiving or transmitting capability of the antenna 10, and can also block and shield interference of another electromagnetic wave from a surface of the other side of the reflection plate 2 to signal receiving.

In the antenna 10 of the base station, the radiating part 1 may receive or transmit a radio frequency signal through a respective feeding structure 3. The feeding structure 3 generally includes a controlled impedance transmission line. The feeding structure 3 may feed a radio signal to the radiating part 1 depending on the amplitude and phase, or send a received radio signal to the signal processing unit 60 of the base station depending on the amplitude and phase. As shown in FIG. 3, the feeding structure 3 may further implement different radiation beam directions through a transmission component 301, or may be connected to a calibration network 302 to obtain a calibration signal required by the system. In addition, the feeding structure 3 may include a phase shifter 303, to change a maximum direction of antenna signal radiation. In addition, the feeding structure 3 may be further provided with modules configured to extend performance, such as a combiner 304 and a filter 305. The combiner 304 may be configured to combine signals of different frequencies into one signal, and transmit the signal through the antenna 10; or in reverse use, may be configured to divide a signal received by the antenna 10 into a plurality of signals based on different frequencies and transmit the signals to the signal processing unit 60 for processing. The filter 305 may be configured to filter out an interference signal.

Currently, a quantity of antennas on a base station tower is increasing, and available space of the base station tower is limited. Therefore, a multi-band antenna integrating antenna arrays of a plurality of frequency bands gradually becomes a mainstream antenna development direction. A common multi-band antenna includes a dual-band antenna and a tri-band antenna. It may be understood that the dual-band antenna is an antenna having two operating frequency bands, and the tri-band antenna is an antenna having three operating frequency bands.

A dual-band antenna is used as an example. FIG. 4 is a diagram of a simplified structure of a dual-band antenna according to an embodiment of this application. The dual-band antenna includes a high-frequency antenna element 101 and a low-frequency antenna element 102 that are disposed on a same antenna array plane. In this embodiment of this application, specific operating frequencies of the high-frequency antenna element 101 and the low-frequency antenna element 102 are not limited. However, the operating frequency of the high-frequency antenna element 101 is higher than the operating frequency of the low-frequency antenna element 102. For example, the operating frequency of the high-frequency antenna element 101 may be 30% higher than the operating frequency of the low-frequency antenna element 102.

Referring to FIG. 4, in the dual-band antenna, the high-frequency antenna element 101 and the low-frequency antenna element 102 are disposed close to each other, and a maximum spacing between the two is sometimes less than 0.5 times a wavelength of the low-frequency antenna element 102. The wavelength may be understood as a wavelength corresponding to an operating frequency of the low-frequency antenna element 102 in a vacuum environment, to form a shared-aperture antenna. By using a shared aperture technology, antenna elements of two or even more frequency bands are arranged on a same antenna array plane, so that outline dimensions of a multi-band antenna can be greatly reduced, and application advantages of miniaturization, lightweight, and easy deployment are obtained.

However, still referring to FIG. 4, in the shared-aperture antenna, because a spacing between the high-frequency antenna element 101 and the low-frequency antenna element 102 is small, when an electromagnetic wave radiated by the low-frequency antenna element 102 is coupled to the high-frequency antenna element 101, common-mode resonance is generated on the high-frequency antenna element 101, so that a low-frequency common-mode induced current is excited on a radiating part and a reflection ground of the high-frequency antenna element 101, and the common-mode induced current further stimulates a low-frequency electromagnetic wave. The low-frequency electromagnetic wave is superimposed with an electromagnetic wave directly radiated by the low-frequency antenna element 102, causing deterioration of directivity pattern parameters such as gain stability and a polarization suppression ratio of the low-frequency antenna element 102.

Based on this, an embodiment of this application provides an antenna, to improve directivity pattern parameters such as a polarization suppression ratio and gain stability of a low-frequency antenna element 102 in the antenna and further ensure radiation efficiency and operating stability of a high-frequency antenna element 101.

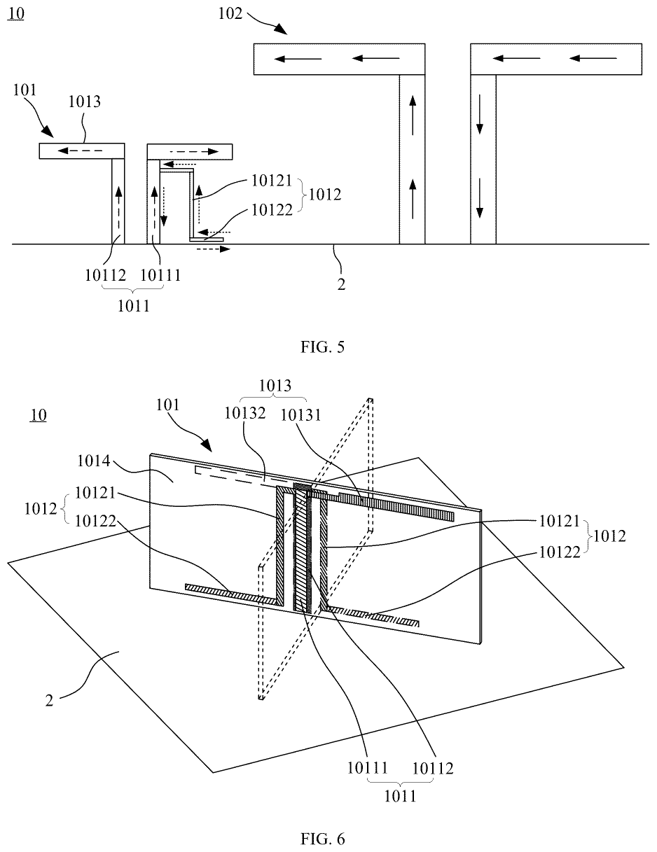

FIG. 5 is a diagram of a simplified structure of an antenna according to an embodiment of this application. The antenna includes a reflection plate 2 and an antenna element disposed on a surface of one side of the reflection plate 2. A material of the reflection plate 2 may be but is not limited to metal such as gold, silver, copper, iron, and aluminum, or may be alloy such as stainless steel, aluminum alloy, and nickel alloy. In this embodiment of this application, the antenna element may include at least one low-frequency antenna element 102 and at least one high-frequency antenna element 101, the low-frequency antenna element 102 is located on a periphery of the high-frequency antenna element 101, and the low-frequency antenna element 102 and the high-frequency antenna element 101 may be but are not limited to being disposed on a same side of the reflection plate 2 in an array.

Referring to FIG. 5, in this embodiment of this application, the high-frequency antenna element 101 may further include a feed line 1011 and a decoupling stub 1012. The feed line 1011 may be configured to feed the high-frequency antenna element 101, the decoupling stub 1012 may be connected to the feed line 1011, and the decoupling stub 1012 is configured to move a gain-drop point of the low-frequency antenna element 102 outside an operating frequency band, to improve a directivity pattern parameter of the low-frequency antenna element 102.

FIG. 6 is a diagram of a partial structure of the antenna according to an embodiment of this application. A structure of the low-frequency antenna element 102 is omitted in FIG. 6. In this embodiment of this application, the feed line 1011 may include a first electrode line 10111 and a second electrode line 10112. For example, the first electrode line 10111 may be a positive electrode line, and the second electrode line 10112 may be a negative electrode line. In this case, the second electrode line 10112 may be connected to the reflection plate 2.

In this example, the feed line 1011 is perpendicular to a surface of the reflection plate 2. In this case, both the first electrode line 10111 and the second electrode line 10112 are perpendicular to the surface of the reflection plate 2. In this example, a specific disposition form of the feed line 1011 is not limited. For example, the feed line 1011 may be a microstrip structure, a coaxial feed line, a strip line, or a coplanar waveguide (CPW) transmission line. In this embodiment of this application, a structure of the antenna is described by using an example in which the feed line 1011 is a microstrip structure.

Referring to FIG. 6, when the feed line 1011 is a microstrip structure, to avoid a short circuit between the first electrode line 10111 and the second electrode line 10112, the first electrode line 10111 and the second electrode line 10112 may be respectively located on two surfaces that are spaced apart. Specifically, the high-frequency antenna element 101 may include a dielectric substrate 1014. The dielectric substrate 1014 may be perpendicular to the reflection plate 2, that is, two surfaces of the dielectric substrate 1014 that are disposed opposite to each other are perpendicular to the surface of the reflection plate 2. In this way, the first electrode line 10111 and the second electrode line 10112 may be respectively disposed on the two surfaces of the dielectric substrate 1014 that are disposed opposite to each other, and the first electrode line 10111 and the second electrode line 10112 are disposed opposite to each other, so that the first electrode line 10111 and the second electrode line 10112 are separated by the dielectric substrate 1014. In this example, a specific disposition form of the dielectric substrate 1014 is not limited. For example, the dielectric substrate 1014 may be a printed circuit board (PCB). In this way, the first electrode line 10111 and the second electrode line 10112 may be cables disposed on surfaces of two sides of the PCB, and materials of the first electrode line 10111 and the second electrode line 10112 may be but are not limited to metal such as copper, so that a manner of forming the feed line 1011 can be simplified.

Still referring to FIG. 6, the high-frequency antenna element 101 may include a radiation arm 1013. The radiation arm 1013 may include a first radiation arm 10131 and a second radiation arm 10132. The first radiation arm 10131 and the second radiation arm 10132 are located on a same radiation surface, and the radiation surface is parallel to the surface of the reflection plate 2. In this example, the feed line 1011 may be located between the radiation surface and the reflection plate 2. In addition, the first electrode line 10111 may be connected to the first radiation arm 10131, and the second electrode line 10112 may be connected to the second radiation arm 10132. Specifically, an end that is of the first electrode line 10111 and that is away from the reflection plate 2 may be connected to the first radiation arm 10131, and an end that is of the second electrode line 10112 and that is away from the reflection plate 2 may be connected to the second radiation arm 10132, so that the feed line 1011 feeds the first radiation arm 10131 and the second radiation arm 10132. It should be noted that, because the two electrode lines of the feed line 1011 are respectively connected to the corresponding radiation arms, an end that is of the feed line 1011 and that is away from the reflection plate 2 may be located on the radiation surface.

In this example, the first electrode line 10111 and the first radiation arm 10131 may be disposed on a same plane, and the second electrode line 10112 and the second radiation arm 10132 may be disposed on a same plane, so that interference between each electrode line and radiation arm can be effectively avoided. Because the dielectric substrate 1014 may be a PCB, in this embodiment of this application, the first radiation arm 10131 and the second radiation arm 10132 may alternatively be cables disposed on a surface of the PCB. In addition, the first electrode line 10111 and the first radiation arm 10131 may be of an integrated structure, and the second electrode line 10112 and the second radiation arm 10132 may be of an integrated structure, so that a structure of a high-frequency antenna can be simplified, and impedance between the first electrode line 10111 and the first radiation arm 10131 and between the second electrode line 10112 and the second radiation arm 10132 can be reduced.

When the decoupling stub 1012 is disposed, still referring to FIG. 6, the decoupling stub 1012 includes a first stub 10121 and a second stub 10122. The first stub 10121 is perpendicular to the surface of the reflection plate 2. In addition, because the feed line 1011 is perpendicular to the surface of the reflection plate 2, the first stub 10121 is parallel to the feed line 1011. The second stub 10122 is located on a side that is of the first stub 10121 and that is close to the reflection plate 2. In other words, the second stub 10122 is located on a side that is of the first stub 10121 and that is away from the radiation arm 1013. In addition, the second stub 10122 is connected to the first stub 10121, the second stub 10122 extends from the first stub 10121 in a direction away from the feed line 1011, and the second stub 10122 is parallel to the reflection plate 2. Because the feed line 1011 and the first stub 10121 are perpendicular to the reflection plate 2, the second stub 10122 is perpendicular to the feed line 1011 and the first stub 10121.

It should be noted that, in this example, the decoupling stub 1012 may be disposed with reference to a manner of disposing the feed line 1011. Specifically, the first stub 10121 and the second stub 10122 may be cables disposed on a surface of the dielectric substrate 1014, and materials of the first stub 10121 and the second stub 10122 may be but are not limited to metal such as copper, so that a manner of forming the decoupling stub 1012 can be simplified.

In this embodiment of this application, a specific length of the first stub 10121 is not limited. For example, the length of the first stub 10121 may be 0.125 to 0.25 times a wavelength corresponding to an operating frequency of the high-frequency antenna element 101. When the low-frequency antenna element 102 operates, a flow direction of a current on the first stub 10121 is opposite to a flow direction of an induced current on an electrode line of the feed line 1011. Therefore, by setting the length of the first stub 10121 to the foregoing value, the currents on the first stub 10121 and the electrode line of the feed line 1011 can be at least partially offset, thereby greatly reducing interference of the high-frequency antenna element 101 to the low-frequency antenna element 102. In addition, in this example, the length of the first stub 10121 may be less than or equal to a length of the feed line 1011. Similar to the foregoing principle, making the length of the first stub 10121 less than or equal to the length of the feed line 1011 can also reduce interference of the high-frequency antenna element 101 to the low-frequency antenna element 102.

In this example, a length of the second stub 10122 may also be 0.125 to 0.25 times the wavelength corresponding to the operating frequency of the high-frequency antenna element 101. This can make a gain-drop resonance point of the low-frequency antenna element 102 outside an operating frequency band of the low-frequency antenna element 102, so that interference of the high-frequency antenna element 101 to the low-frequency antenna element 102 is reduced, thereby improving directivity pattern parameters such as a polarization suppression ratio and gain stability of the low-frequency antenna element 102.

Based on the foregoing descriptions of the lengths of the first stub 10121 and the second stub 10122 of the decoupling stub 1012, in this example, a sum of the length of the first stub 10121 and the length of the second stub 10122 may be 0.25 to 0.5 times the wavelength corresponding to the operating frequency of the high-frequency antenna element 101, to improve directivity pattern parameters such as a polarization suppression ratio and gain stability of the low-frequency antenna element 102.

In addition, in this example, line widths of the first stub 10121 and the second stub 10122 of the decoupling stub 1012 are not limited, and may be set according to an impedance requirement of the high-frequency antenna element 101, to implement impedance matching of the high-frequency antenna element 101, thereby reducing impact of the decoupling stub 1012 on radiation of the high-frequency antenna element 101.

It may be understood that, in this example, there is a specific spacing between the second stub 10122 and the surface of the reflection plate 2, to avoid a short circuit between the second stub 10122 and the reflection plate 2. The spacing between the second stub 10122 and the surface of the reflection plate 2 is not limited in this embodiment of this application. For example, the spacing between the second stub 10122 and the surface of the reflection plate 2 may be 0.1 times the wavelength corresponding to the operating frequency of the high-frequency antenna element 101. This design can make a gain-drop resonance point of the low-frequency antenna element 102 move outside an operating frequency band of the low-frequency antenna element 102, and can also avoid impact on radiation of the high-frequency antenna element 101.

Still referring to FIG. 6, when the decoupling stub 1012 is connected to the feed line 1011, an end that is of the first stub 10121 and that is away from the reflection plate 2 may be connected to the feed line 1011. The decoupling stub 1012 is also located between the radiation arm 1013 and the reflection plate 2, and the end that is of the first stub 10121 and that is away from the reflection plate 2 is also an end that is of the first stub 10121 and that is close to the radiation arm 1013.

Because the feed line 1011 includes the first electrode line 10111 and the second electrode line 10112, in the antenna shown in FIG. 6, the high-frequency antenna element 101 includes two decoupling stubs 1012. An end that is of a first stub 10121 of one decoupling stub 1012 and that is away from the reflection plate 2 is connected to the first electrode line 10111, and an end that is of a first stub 10121 of the other decoupling stub 1012 and that is away from the reflection plate 2 is connected to the second electrode line 10112. The one decoupling stub 1012 and the first electrode line 10111 may be disposed on a same plane, and the other decoupling stub 1012 and the second electrode line 10112 may be disposed on a same plane. For example, both the one decoupling stub 1012 and the first electrode line 10111 may be disposed on one surface of the dielectric substrate 1014, and both the other decoupling stub 1012 and the second electrode line 10112 may be disposed on the other surface of the dielectric substrate 1014. In this case, the two decoupling stubs 1012 may also be cables formed on the dielectric substrate 1014. In addition, each decoupling stub 1012 may be further of an integrated structure with an electrode line and a radiation arm that are disposed on a same plane, so that a processing process of the high-frequency antenna element 101 can be simplified, thereby improving processing efficiency of the high-frequency antenna.

When the decoupling stub 1012 is connected to a corresponding electrode line, a manner of connecting the decoupling stub 1012 to the first electrode line 10111 is used for description. As shown in FIG. 6, a distance between the end that is of the first stub 10121 and that is away from the reflection plate 2 and the reflection plate is equal to a distance between the end that is of the first electrode line 10111 and that is away from the reflection plate 2 and the reflection plate. Therefore, the end that is of the first stub 10121 and that is away from the reflection plate 2 may be flush with and connected to the end that is of the first electrode line 10111 and that is away from the reflection plate 2. In this case, a connection line between the first stub 10121 and the first electrode line 10111 is parallel to the surface of the reflection plate 2. Alternatively of this application, the end that is of the first stub 10121 and that is away from the reflection plate 2 may be closer to the reflection plate 2 than the end that is of the first electrode line 10111 and that is away from the reflection plate 2. In this case, a connection line between the end that is of the first stub 10121 and that is away from the reflection plate 2 and the first electrode line 10111 may be parallel to the surface of the reflection plate 2, so that the end that is of the first stub 10121 and that is away from the reflection plate 2 is connected to a middle position of the first electrode line 10111. In addition, the end that is of the first stub 10121 and that is away from the reflection plate 2 may be further connected to the end that is of the first electrode line 10111 and that is away from the reflection plate 2. In this case, a connection line between the first stub 10121 and the first electrode line 10111 may be at a specific angle with the surface of the reflection plate 2.

It should be noted that the end that is of the feed line 1011 and that is away from the reflection plate 2 is located on the radiation surface on which the radiation arm 1013 of the high-frequency antenna element 101 is located. Therefore, in a possible embodiment of this application, the end that is of the first stub 10121 and that is away from the reflection plate 2 may be close to or located on the radiation surface. In addition, because a spacing between the second stub 10122 and the reflection plate 2 is small, when the low-frequency antenna element 102 operates, a flow direction of a current on the first stub 10121 is opposite to a flow direction of an induced current generated on the feed line 1011. In this case, the current on the first stub 10121 and the induced current generated on the feed line 1011 may offset, thereby greatly reducing interference of the high-frequency antenna element 101 to the low-frequency antenna element 102.

In the embodiment shown in FIG. 6, a manner of connecting the decoupling stub 1012 to the second electrode line 10112 is similar to the manner of connecting the decoupling stub 1012 to the first electrode line 10111. Details are not described herein again. In addition, it may be understood that in the embodiment shown in FIG. 6, the decoupling stub 1012 connected to the first electrode line 10111 and the first radiation arm 10131 are respectively disposed on two sides of the first electrode line 10111, and the decoupling stub 1012 connected to the second electrode line 10112 and the second radiation arm 10132 are respectively disposed on two sides of the second electrode line 10112. In another possible embodiment of this application, the decoupling stub 1012 connected to the first electrode line 10111 and the first radiation arm 10131 may alternatively be located on a same side of the first electrode line 10111, and the decoupling stub 1012 connected to the second electrode line 10112 and the second radiation arm 10132 may alternatively be located on a same side of the second electrode line 10112. In this case, relative locations of the decoupling stub 1012 connected to the first electrode line 10111 and the first radiation arm 10131, and the first electrode line 10111, and relative locations of the decoupling stub 1012 connected to the second electrode line 10112 and the second radiation arm 10132, and the second electrode line 10112 are not limited in this application.

Still referring to FIG. 6, the high-frequency antenna element 101 may include two dielectric substrates 1014, and the two dielectric substrates 1014 are perpendicular and intersect. The two dielectric substrates 1014 may be assembled in a plug-in manner, thereby making assembly of the high-frequency antenna element 101 flexible. In a possible embodiment of this application, the two dielectric substrates 1014 of the high-frequency antenna element 101 may alternatively be of an integrated structure, thereby effectively improving structure reliability of the high-frequency antenna element 101.

In FIG. 6, to facilitate description of a specific manner of disposing the feed line 1011, the decoupling stub 1012, and the radiation arm 1013 of the high-frequency antenna element 101, only a structure of one dielectric substrate 1014 of the high-frequency antenna element 101 is shown. Next, to further describe the antenna shown in FIG. 6, FIG. 7 is a diagram of a structure of the other dielectric substrate of the high-frequency antenna element 101 of the antenna provided in FIG. 6. Similarly, for ease of display of the structure of the other dielectric substrate of the high-frequency antenna element 101, a feed line 1011, a decoupling stub 1012, and a radiation arm 1013 of one dielectric substrate of the high-frequency antenna element 101 in FIG. 6 are omitted in FIG. 7. Referring to FIG. 6 and FIG. 7 together, in this embodiment of this application, the high-frequency antenna element 101 may further include a third radiation arm 10133 and a fourth radiation arm 10134. In this case, the first radiation arm 10131 and the second radiation arm 10132 are disposed on one dielectric substrate 1014, and the third radiation arm 10133 and the fourth radiation arm 10134 are disposed on the other dielectric substrate 1014. In addition, the first radiation arm 10131, the second radiation arm 10132, the third radiation arm 10133, and the fourth radiation arm 10134 may be disposed on a same radiation surface.

As shown in FIG. 6 and FIG. 7, in this example, a feed line 1011 may be disposed on each dielectric substrate 1014 of the high-frequency antenna element 101. A first electrode line 10111 and a second electrode line 10112 of each feed line 1011 are respectively disposed on two surfaces of a corresponding dielectric substrate 1014 that are disposed opposite to each other, and the feed line 1011 of each dielectric substrate 1014 is connected to a first stub 10121 of a corresponding decoupling stub 1012. The feed lines 1011 of the two dielectric substrates 1014 may be disposed in a same manner or in different manners. For example, in the antennas shown in FIG. 6 and FIG. 7, a manner of disposing the feed lines 1011 of the two dielectric substrates 1014 and a manner of connecting the feed lines 1011 to the decoupling stubs 1012 are the same, and reference may be made to FIG. 6. Details are not described herein again.

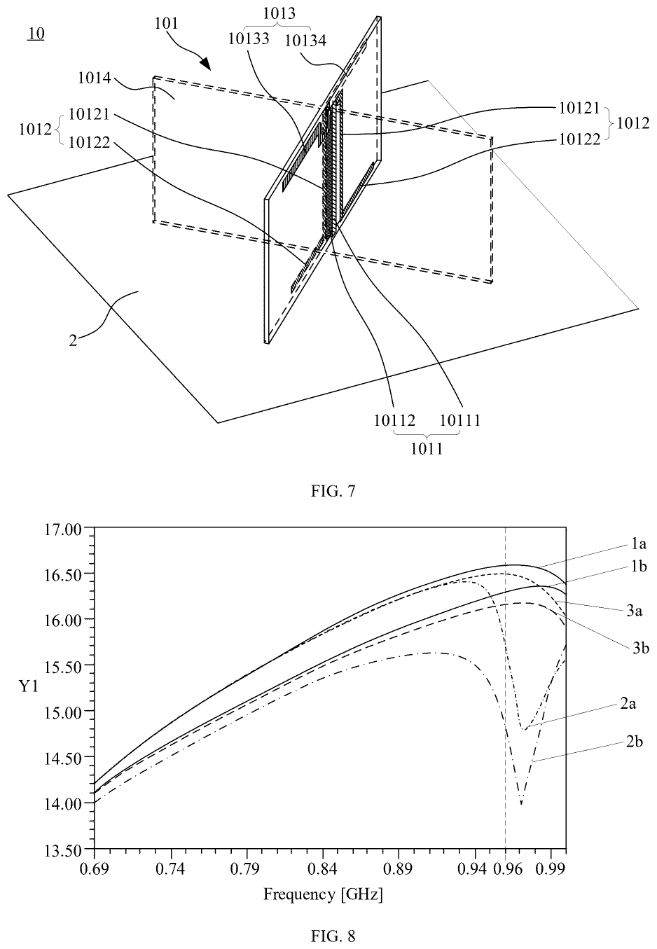

In addition, FIG. 8 shows a curve of a gain simulation result of a low-frequency antenna element of the antenna shown in FIG. 6 and FIG. 7. In FIG. 8, a horizontal coordinate represents an operating frequency, and a vertical coordinate represents a gain; curves 1a and 1b are gain simulation structure curves of a low-frequency antenna element array including only an antenna of a low-frequency antenna element array, and may be used as reference curves; curves 2a and 2b are gain simulation structure curves of a low-frequency antenna element array including antennas of both a low-frequency antenna element array and a high-frequency antenna element array, where no decoupling stub is disposed in a high-frequency antenna element; and curves 3a and 3b are gain simulation structure curves of a low-frequency antenna element array including antennas of both a low-frequency antenna element array and a high-frequency antenna element array, where a high-frequency antenna element is the high-frequency antenna element described in FIG. 6 and FIG. 7.

It can be learned from comparison of gain simulation structures of the low-frequency antenna element arrays including the antennas shown in FIG. 8 that, in the antenna provided in this example, the decoupling stub is disposed in the high-frequency antenna element, so that interference of the high-frequency antenna element to the low-frequency antenna element can be effectively reduced, thereby increasing a gain of the low-frequency antenna element.

In the antenna provided in the foregoing embodiment of this application, the feed line 1011 and the decoupling stub 1012 of the high-frequency antenna element 101 are connected. When the low-frequency antenna element 102 operates, referring to FIG. 5, an induced current is generated on the feed line 1011. However, because the first stub 10121 of the decoupling stub 1012 is disposed in parallel to the feed line 1011, and a flow direction of a current on the first stub 10121 is opposite to a flow direction of an induced current on an electrode line of the feed line 1011, the currents on the first stub 10121 and the feed line 1011 can be at least partially offset, thereby greatly reducing interference of the high-frequency antenna element 101 to the low-frequency antenna element 102, and helping improve directivity pattern parameters such as a polarization suppression ratio and gain stability of the low-frequency antenna element 102. In addition, when the high-frequency antenna element 101 operates in a frequency band of the high-frequency antenna element 101, because the flow direction of the current on the first stub 10121 of the decoupling stub 1012 is opposite to the flow direction of the current on the feed line 1011, the second stub 10122 of the decoupling stub 1012 is parallel to the reflection plate 2, and the spacing between the second stub 10122 and the reflection plate 2 is small, a flow direction of a current on the second stub 10122 is opposite to a flow direction of an induced current on the reflection plate 2, so that disposition of the decoupling stub 1012 has little impact on radiation of the high-frequency antenna element 101.

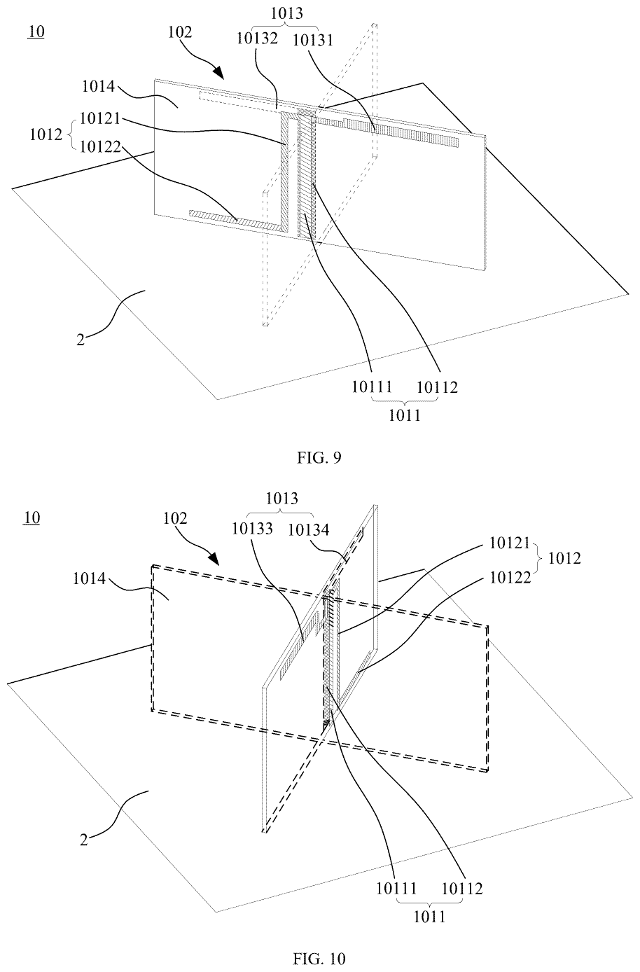

In the antenna shown in FIG. 6 and FIG. 7 in this example, the first electrode line 10111 and the second electrode line 10112 of the feed line 1011 of the high-frequency antenna element 101 each are connected to the decoupling stub 1012. Alternatively of this application, alternatively, only the first electrode line 10111 or the second electrode line 10112 of the feed line 1011 may be connected to the decoupling stub 1012. For example, FIG. 9 is a diagram of another structure of an antenna according to an embodiment of this application. Compared with the antenna shown in FIG. 6, in the antenna shown in FIG. 9, only the first electrode line 10111 of the feed line 1011 of the high-frequency antenna element 101 is connected to the decoupling stub 1012, and the second electrode is not connected to the decoupling stub 1012. For a manner of connecting the first electrode line 10111 of the feed line 1011 of the high-frequency antenna element 101 of the antenna shown in FIG. 9 to the decoupling stub 1012 and another structure of the antenna, refer to the antenna shown in FIG. 9. Details are not described herein again.

The antenna shown in FIG. 9 shows only a structure of one dielectric substrate 1014 of the high-frequency antenna element 101. To show another structure of the high-frequency antenna element 101 of the antenna shown in FIG. 9, refer to FIG. 10. FIG. 10 is a diagram of a structure of the other dielectric substrate of the high-frequency antenna element 101 of the antenna provided in FIG. 9. In the high-frequency antenna elements of the antennas shown in FIG. 9 and FIG. 10, a manner of disposing the feed lines 1011 of the two dielectric substrates 1014 and a manner of connecting the feed lines 1011 to the decoupling stubs 1012 are the same, and reference may be made to FIG. 9. Details are not described herein again.

In addition, FIG. 11 is a diagram of another structure of an antenna according to an embodiment of this application. Compared with the antenna shown in FIG. 6, in the antenna shown in FIG. 11, only the second electrode line 10112 of the feed line 1011 of the high-frequency antenna element 101 is connected to the decoupling stub 1012, and the first electrode is not connected to the decoupling stub 1012. For a manner of connecting the second electrode line 10112 of the feed line 1011 of the high-frequency antenna element 101 of the antenna shown in FIG. 11 to the decoupling stub 1012 and another structure of the antenna, refer to the antenna shown in FIG. 6. Details are not described herein again.

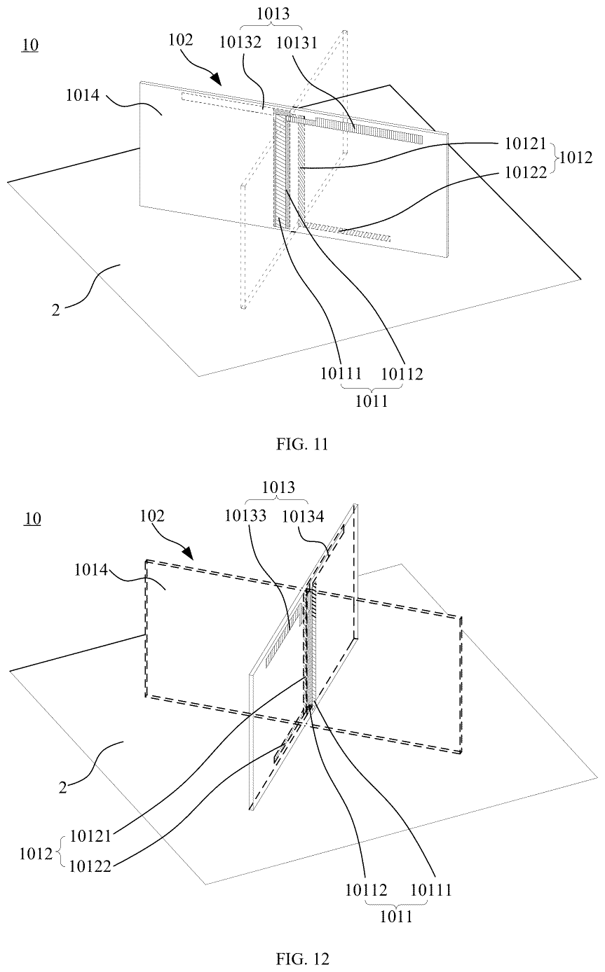

The antenna shown in FIG. 11 shows only a structure of one dielectric substrate 1014 of the high-frequency antenna element 101. To show another structure of the high-frequency antenna element 101 of the antenna shown in FIG. 11, refer to FIG. 12. FIG. 12 is a diagram of a structure of the other dielectric substrate of the high-frequency antenna element 101 of the antenna provided in FIG. 11. In the high-frequency antenna elements of the antennas shown in FIG. 11 and FIG. 12, a manner of disposing the feed lines 1011 of the two dielectric substrates 1014 and a manner of connecting the feed lines 1011 to the decoupling stubs 1012 are the same, and reference may be made to FIG. 11. Details are not described herein again.

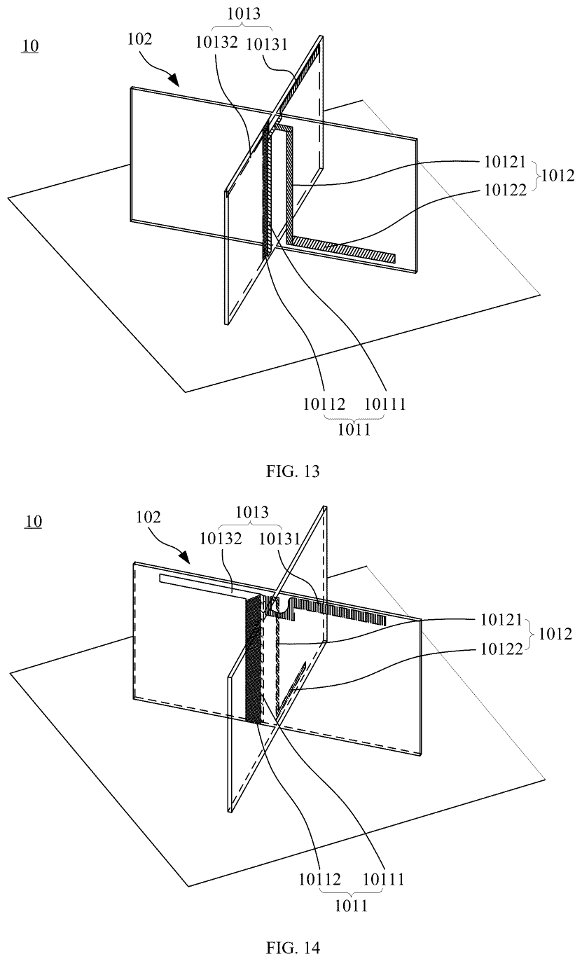

In the foregoing embodiment of this application, an electrode line that is of the feed line 1011 of the high-frequency antenna element 101 and that is connected to the decoupling stub 1012 and the corresponding decoupling stub 1012 are disposed on a same plane. In some possible embodiments of this application, an electrode line and a decoupling stub 1012 correspondingly connected to the electrode line may be alternatively disposed on two different planes. FIG. 13 is a diagram of another structure of an antenna according to an embodiment of this application. In the high-frequency antenna element 101 of the antenna, the first electrode line 10111 of each feed line 1011 is connected to the decoupling stub 1012, and the second electrode line 10112 is not connected to the decoupling stub 1012. A plane on which the decoupling stub 1012 is located is perpendicular to and intersects a plane on which the first electrode line 10111 is located, and the end that is of the first stub 10121 of the decoupling stub 1012 and that is away from the reflection plate 2 is connected to the first electrode line 10111.

Referring to FIG. 13, because the high-frequency antenna element 101 may include two dielectric substrates 1014 that are perpendicular and intersect, for the decoupling stub 1012 and the first electrode line 10111 that are connected, the first electrode line 10111 may be disposed on one dielectric substrate 1014, and the decoupling stub 1012 may be disposed on the other dielectric substrate 1014. In addition, for a specific manner of disposing the first electrode line 10111 and the decoupling stub 1012, a manner of connecting the first electrode line 10111 to the first stub 10121, and the like, refer to the foregoing embodiment. Details are not described herein again.

The antenna shown in FIG. 13 shows only a manner of connecting a first electrode line 10111 on one dielectric substrate 1014 of the high-frequency antenna element 101 to a decoupling stub 1012. Based on this, it may be understood that a manner of connecting a first electrode line 10111 on the other dielectric substrate 1014 of the high-frequency antenna element 101 to a corresponding decoupling stub 1012 may be obtained by rotating the high-frequency antenna element 101 shown in FIG. 13 counterclockwise by 90° around an intersection line of the two dielectric substrates 1014, as shown in FIG. 14. FIG. 14 is a diagram of a manner of connecting a first electrode line 10111 on the other dielectric substrate 1014 of the high-frequency antenna element 101 of the antenna provided in FIG. 13 to a corresponding decoupling stub 1012. For the manner of connecting the first electrode line 10111 on the other dielectric substrate 1014 of the high-frequency antenna element 101 in FIG. 14 to the corresponding decoupling stub 1012, refer to FIG. 13. Details are not described herein again. In addition, for another structure of the antenna provided in this embodiment of this application, refer to any one of the foregoing embodiments. Details are not described herein again.

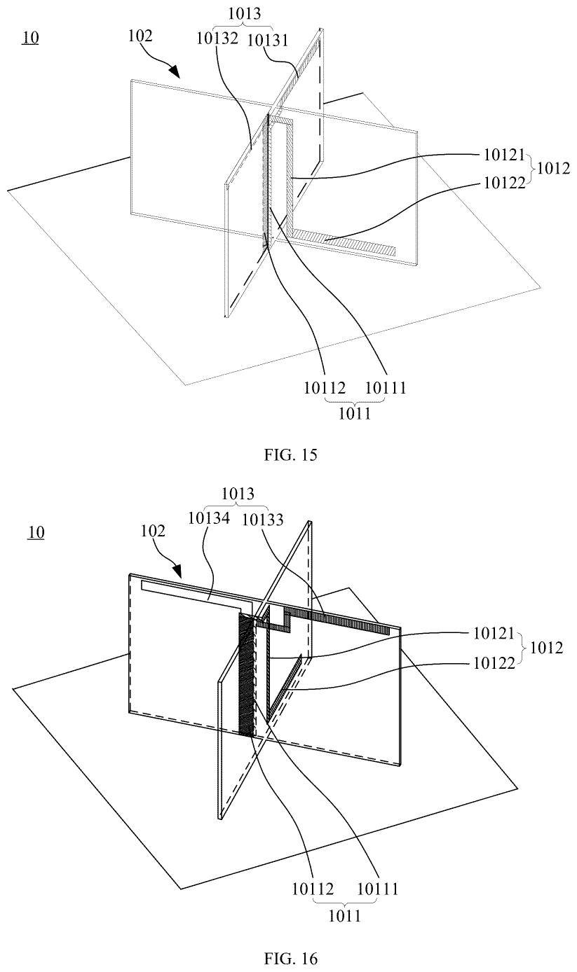

In addition, FIG. 15 is a diagram of another structure of an antenna according to an embodiment of this application. In the high-frequency antenna element 101 of the antenna, the second electrode line 10112 of each feed line 1011 is connected to the decoupling stub 1012, and the first electrode line 10111 is not connected to the decoupling stub 1012. A plane on which the decoupling stub 1012 is located is perpendicular to and intersects a plane on which the second electrode line 10112 is located, and the end that is of the first stub 10121 of the decoupling stub 1012 and that is away from the reflection plate 2 is connected to the second electrode line 10112.

Referring to FIG. 15, because the high-frequency antenna element 101 may include two dielectric substrates 1014 that are perpendicular and intersect, for the decoupling stub 1012 and the second electrode line 10112 that are connected, the second electrode line 10112 may be disposed on one dielectric substrate 1014, and the decoupling stub 1012 may be disposed on the other dielectric substrate 1014. In addition, for a specific manner of disposing the second electrode line 10112 and the decoupling stub 1012, a manner of connecting the second electrode line 10112 to the first stub 10121, and the like, refer to the foregoing embodiment. Details are not described herein again.

The antenna shown in FIG. 15 shows only a manner of connecting a second electrode line 10112 on one dielectric substrate 1014 of the high-frequency antenna element 101 to a decoupling stub 1012. Based on this, it may be understood that a manner of connecting a second electrode line 10112 on the other dielectric substrate 1014 of the high-frequency antenna element 101 to a corresponding decoupling stub 1012 may be obtained by rotating the high-frequency antenna element 101 shown in FIG. 15 counterclockwise by 90° around an intersection line of the two dielectric substrates 1014, as shown in FIG. 16. FIG. 16 is a diagram of a manner of connecting a second electrode line 10112 on the other dielectric substrate 1014 of the high-frequency antenna element 101 of the antenna provided in FIG. 15 to a corresponding decoupling stub 1012. For another structure of the antenna provided in this embodiment of this application, refer to any one of the foregoing embodiments. Details are not described herein again.

Based on the foregoing descriptions of the high-frequency antenna element 101 in FIG. 15 and FIG. 16 in which an electrode line and a decoupling stub 1012 correspondingly connected to the electrode line are respectively disposed on two different planes, in some possible embodiments of this application, the first electrode line 10111 and the second electrode line 10112 of the feed line 1011 of each substrate of the high-frequency antenna element 101 each may be connected to the decoupling stub 1012. For a manner of connecting the first electrode line 10111 to the corresponding decoupling stub 1012, refer to FIG. 13 and FIG. 14. For a manner of connecting the second electrode line 10112 to the corresponding decoupling stub 1012, refer to FIG. 15 and FIG. 16. Details are not described herein again.

In addition, it should be noted that, in the antenna provided in this embodiment of this application, the feed lines 1011 on the two dielectric substrates 1014 of the high-frequency antenna element 101 may be connected to the corresponding decoupling stubs 1012 in different manners. For example, the feed line 1011 on one dielectric substrate 1014 and the corresponding decoupling stub 1012 may be disposed with reference to the manner of connecting the feed line 1011 to the decoupling stub 1012 shown in FIG. 6, and the feed line 1011 on the other dielectric substrate 1014 and the corresponding decoupling stub 1012 may be disposed with reference to the manner of connecting the feed line 1011 to the decoupling stub 1012 shown in FIG. 11, provided that interference between the structures can be avoided.

In the foregoing embodiment of this application, a dual-band antenna including both a low-frequency antenna element 102 and a high-frequency antenna element 101 is used as an example to describe improvement to directivity pattern parameters such as a polarization suppression ratio and gain stability of the low-frequency antenna element 102 and avoiding impact on radiation of the high-frequency antenna element 101 by disposing the decoupling stub 1012 in the high-frequency antenna element 101. Based on this, it may be understood that, in some other antennas for which directivity pattern parameters such as a polarization suppression ratio and gain stability of an antenna element need to be improved, a decoupling stub 1012 may be further disposed in another antenna element that may interfere with the antenna element, to improve the directivity pattern parameters such as the polarization suppression ratio and the gain stability of the antenna element. For a specific manner of disposing the antenna element with the decoupling stub 1012 connected, refer to the high-frequency antenna element in any one of the foregoing embodiments. Details are not described herein.

This application further provides a communication device. The communication device includes the antenna in any one of the foregoing embodiments, and the communication device may be but is not limited to a base station, a radar, or another device. In the communication device, the decoupling stub 1012 is disposed in the high-frequency antenna element 101, so that a common-mode induced current generated on the high-frequency antenna element 101 when the low-frequency antenna element 102 operates can be effectively suppressed, thereby significantly improving directional parameters such as a polarization suppression ratio and gain stability of the low-frequency antenna element 102. In addition, disposition of the decoupling stub 1012 in the high-frequency antenna element 101 basically does not affect radiation of the high-frequency antenna element 101, thereby ensuring radiation efficiency and operating stability of the high-frequency antenna element 101. In addition, manufacturing costs of the antenna are low, so that costs of the entire communication device can be effectively reduced.

It is clear that a person skilled in the art can make various modifications and variations to this application without departing from the protection scope of this application. This application is intended to cover these modifications and variations of this application provided that they fall within the scope of protection defined by the following claims and their equivalent technologies.

1. An antenna element, comprising a radiation arm, a feed line, and a decoupling stub, wherein the radiation arm is connected to the feed line; and
the decoupling stub comprises a first stub and a second stub, the first stub is parallel to the feed line, and an end of the first stub is connected to the feed line; and the second stub is located on a first side of the first stub away from the radiation arm, the second stub is connected to the first stub, the second stub extends from the first stub to a second side away from the feed line, and the second stub is perpendicular to the feed line.

2. The antenna element according to claim 1, wherein a length of the first stub is 0.125 to 0.25 times a wavelength corresponding to an operating frequency of the antenna element.

3. The antenna element according to claim 1, wherein a length of the second stub is 0.125 to 0.25 times a wavelength corresponding to an operating frequency of the antenna element.

4. The antenna element according to claim 1, wherein a sum of the a length of the first stub and a length of the second stub is 0.25 to 0.5 times a wavelength corresponding to an operating frequency of the antenna element.

5. The antenna element according to claim 1, wherein a length of the first stub is less than or equal to a length of the feed line.

6. The antenna element according to claim 1, wherein the end of the first stub is connected to an end of the feed line that is connected to the radiation arm.

7. The antenna element according to claim 1, wherein the feed line comprises a first electrode line and a second electrode line, the first electrode line and the second electrode line are disposed in parallel, and the end of the first stub is connected to at least one of the first electrode line and the second electrode line.

8. The antenna element according to claim 7, wherein the end of the first stub is connected to the first electrode line; and the decoupling stub and the first electrode line are disposed on a same plane, or a plane on which the decoupling stub is located is perpendicular to and intersects a plane on which the first electrode line is located.

9. The antenna element according to claim 7, wherein the end of the first stub is connected to the second electrode line; and the decoupling stub and the second electrode line are disposed on a same plane, or a plane on which the decoupling stub is located is perpendicular to and intersects a plane on which the second electrode line is located.

10. The antenna element according to claim 7, wherein the decoupling stub is a first decoupling stubes, the antenna element further comprises a second decoupling stub, the first decoupling stub and the second decoupling stub each comprise an end connected to the first electrode line and the second electrode line, respectively.

11. The antenna element according to claim 10, wherein the first decoupling stub and the first electrode line are disposed on a same plane; or a plane on which the first decoupling stub is located is perpendicular to and intersects a plane on which the first electrode line is located.

12. The antenna element according to claim 10, wherein the second decoupling stub and the second electrode line are disposed on a same plane; or a plane on which the second decoupling stub is located is perpendicular to and intersects a plane on which the second electrode line is located.

13. The antenna element according to claim 1, wherein the antenna element comprises two dielectric substrates, and the two dielectric substrates are perpendicular and intersect; and
each of the two dielectric substrates is coupled to the with feed line that has a microstrip structures, a first electrode and a second electrode of the feed line are respectively disposed on two surfaces of a corresponding dielectric substrate, and the feed line is connected to a first stub of a corresponding decoupling stub.

14. The antenna element according to claim 13, wherein the radiation arm comprises a first radiation arm, a second radiation arm, a third radiation arm, and a fourth radiation arm, the first radiation arm and the second radiation arm are disposed on a first dielectric substrate, and the third radiation arm and the fourth radiation arm are disposed on a second dielectric substrate; and the first radiation arm, the second radiation arm, the third radiation arm, and the fourth radiation arm are disposed on a same radiation surface, and the end of the first stub is located on the radiation surface.

15. An antenna, comprising a reflection plate and an antenna element, wherein the antenna element is disposed on a surface of one side of the reflection plate;
wherein the antenna element comprises a radiation arm, a feed line, and a decoupling stub, wherein the radiation arm is connected to the feed line; and
the decoupling stub comprises a first stub and a second stub, the first stub is parallel to the feed line and perpendicular to the reflection plate, and an end of the first stub is connected to the feed line; and the second stub is located on a first side of the first stub away from the radiation arm, the second stub is connected to the first stub, the second stub extends from the first stub to a second side away from the feed line, and the second stub is perpendicular to the feed line.

16. An antenna, wherein the antenna comprises a reflection plate and an antenna element, the antenna element is disposed on a surface of one side of the reflection plate, and the antenna element comprises a feed line and a decoupling stub; and
the decoupling stub comprises a first stub and a second stub, the first stub is perpendicular to the reflection plate, and an end of the first stub away from the reflection plate is connected to the feed line; and the second stub is located on a first side of the first stub and, the second stub is connected to the first stub, the second stub extends from the first stub to a second side away from the feed line, and the second stub is parallel to the reflection plate.

17. The antenna according to claim 16, wherein the antenna element comprises at least one low-frequency antenna element and at least one high-frequency antenna element, and the feed line is configured to feed the high-frequency antenna element.

18. The antenna according to claim 17, wherein a length of the first stub is 0.125 to 0.25 times a wavelength corresponding to an operating frequency of the high-frequency antenna element.

19. The antenna according to claim 17, wherein a length of the second stub is 0.125 to 0.25 times a wavelength corresponding to an operating frequency of the high-frequency antenna element.

20. The antenna according to claim 17, wherein a sum of a length of the first stub and a length of the second stub is 0.25 to 0.5 times a wavelength corresponding to an operating frequency of the high-frequency antenna element.
